(19) United States
(12) Patent Application Publication
(10) Pub. No.: US 2014/0250671 A1
(43) Pub. Date: Sep. 11, 2014

(54) Attachment and hanging accessories for handbags to hang on flat surfaces

(71) Applicant: Lauren Marie Murphy Garcia, Redondo Beach, CA (US)

(72) Inventor: Lauren Marie Murphy Garcia, Redondo Beach, CA (US)

(21) Appl. No.: 13/794,466

(22) Filed: Mar. 11, 2013

(51) Int. Cl. F16M 13/02

(52) U.S. Cl. CPC F16M 13/02
USPC 29/525.03; 248/206.2

(57) ABSTRACT

Devices for bags having one or more straps comprising an attachment case, a clasp, and a hook connected by one or more chains to an annular connector, where the attachment case comprises a top portion and a bottom portion that contains a suction cup for securing the bag to a flat surface.

### CROSS-REFERENCE TO RELATED APPLICATION

This application is a continuation-in-part of U.S. Non-provisional patent application Ser. No. 12/869,744, filed Aug. 27, 2010, which is hereby incorporated herein by reference in its entirety for all purposes.

### TECHNICAL FIELD

The invention relates to the field of handbag accessories and more particularly to devices and methods for suspending bags having one or more straps, e.g., handbags, from a flat surface.

### SUMMARY

Embodiments include devices and methods where a device embodiment may comprise: an attachment case comprising a top portion of an attachment case and a bottom portion of an attachment case, where the top portion of the attachment case and the bottom portion of the attachment case may be fixedly attached at one end by a hinge and detachably attached at an opposite end by one or more detachable connectors; a suction cup, where a bulbous end of the suction cup may be disposed in the top portion of the attachment case and secured by a fastening plate; a pivoting chain attachment device comprising a center aperture and a chain connector, where the center aperture of the pivoting chain attachment device may be disposed about a narrow portion of the suction cup such that the pivoting chain attachment device may rotate freely about the suction cup relative to the attachment case, where the chain connector may be connected to an attachment case chain, and where the suction cup, the fastening plate, and the pivoting chain attachment device may be enclosed within the attachment case when the top portion of the attachment case may be attached to the bottom portion of the attachment case by the hinge and one or more detachable connectors; a clasp, where the clasp may be connected to a clasp chain, and where the clasp may be configured to laterally receive the clasp chain disposed about at least one strap; a hook, where the hook is connected to a hook chain, and where the hook is configured to engage a receiving post; and an annular connector, where the annular connector may be configured to connect the attachment case chain, the clasp chain, and the hook chain.

Optionally, the one or more detachable connectors may be magnets. In some embodiments, the hook may be in the form of an S-shape requiring a lateral movement in two or more directions to laterally disengage the hook from the receiving post. Additionally, the clasp may be heart-shaped. Optionally, the bottom portion of the attachment case may further comprise an opening that forms an aperture, where the size of the aperture may allow passing the attachment chain through when the top portion of the attachment case is attached to the bottom portion of the attachment case by the hinge and one or more detachable connectors. In one embodiment the annular connector may be a key ring. In another embodiment the annular connector is further configured to connect to at least one of: a charm, a second attachment case, a second clasp, and a second hook.

A method embodiment may comprise: connecting, by a device having a clasp connected to a clasp chain, at least one strap of a bag to the device, where the clasp chain is connected to an annular connector; attaching an attachment case of the device to a flat surface using a suction cup affixed to the attachment case, where the attachment case comprises an attachment case chain connected to the annular connector; and engaging, by a hook of the device, the device to at least one receiving post where the hook is detachably attached to the at least one receiving post, and where the hook comprises a hook chain connected to the annular connector; securing the bag to the flat surface, where the connected bag is secured by the attached attachment case and engaged hook.

Optionally, the hook is in the form of an S-shape requiring a lateral movement in two or more directions to laterally disengage the hook from the at least one receiving post. In one embodiment the annular connector may be a key ring. Additionally, the annular connector may further be configured to connect to at least one of: a charm, a second attachment case, a second clasp, and a second hook.

### BRIEF DESCRIPTION OF THE DRAWINGS

Embodiments are illustrated by way of example and not limitation in the figures of the accompanying drawings, and in which:

FIG. 1 depicts an exemplary embodiment of the handbag accessory;

FIG. 2A depicts, in a front view, an exemplary open attachment case;

FIG. 2B depicts, in a rear view, an exemplary open attachment case;

FIG. 2C depicts, in a top view, an exemplary closed attachment case;

FIG. 3 depicts, in a cross-sectional view, a top portion of an exemplary attachment case;

FIG. 4A depicts an exemplary pivoting chain attachment device;

FIG. 4B depicts an exemplary fastening plate;

FIG. 5A depicts an exemplary clasp in a closed position;

FIG. 5B depicts an exemplary clasp in an open position;

FIG. 6 depicts an exemplary clasp engaged to a chain wrapped around a strap of a handbag;

FIG. 7A depicts an engagement procedure of an exemplary hook;

FIG. 7B depicts the resting position of an engaged exemplary hook;

FIG. 7C depicts a removal procedure of an exemplary hook;

FIG. 8 depicts an exemplary attachment case engaged to a flat horizontal surface;

FIG. 9 depicts an exemplary attachment case engaged to a flat vertical surface;

FIG. 10 depicts an exemplary hook engaged to a receiving post; and

FIG. 11 depicts an exemplary hook engaged to a receiving post and an exemplary attachment case engaged to a flat surface.

### DETAILED DESCRIPTION

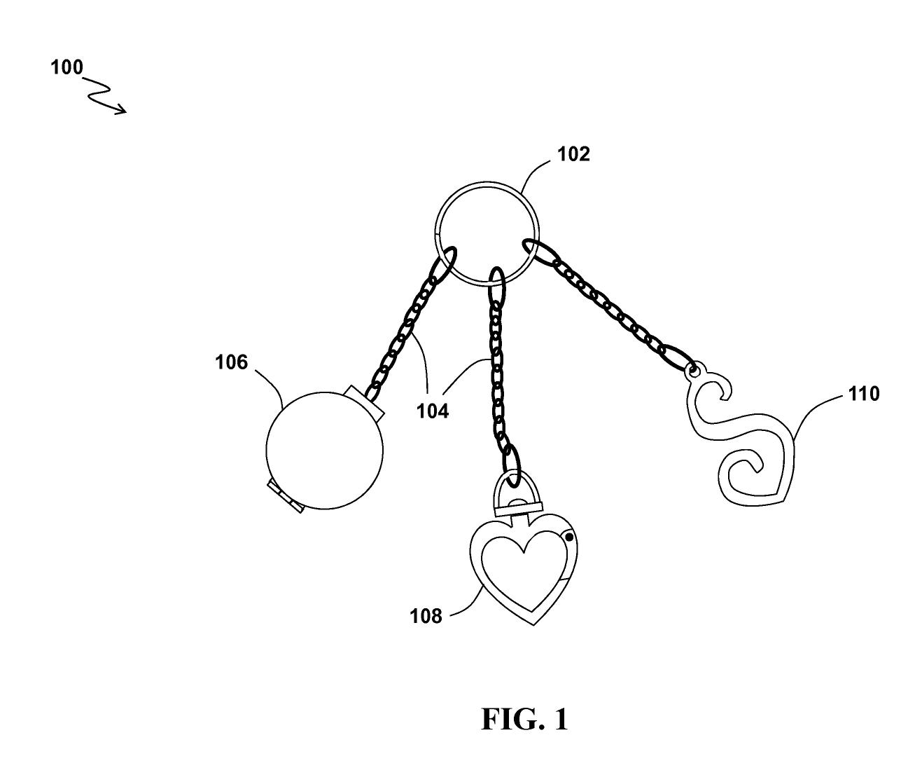

FIG. 1 depicts an exemplary embodiment of the handbag accessory 100. The handbag accessory 100 may comprise an attachment case 106, a clasp 108, and a hook 110. The attachment case 106, the clasp 108, and the hook 110 may each comprise a chain 104 that attaches each respective part to an annular connector 102. In some embodiments, the hook 110 may be used to hold additional bags, e.g., a shopping bag, a diaper bag, etc. In some embodiments, the annular connector 102 may be a key ring or other device that allows the addition of one or more parts, e.g., keys, charms, accessories, and/or additional attachment devices. The chain 104 may be made of interlocking links, but is understood to also include ropes, cables, cords, and/or other suitable materials. The handbag accessory 100 may be made from metal, plastic, or some combination. The annular connector 102 may be used to add additional connectors and/or ornaments, e.g., lipstick, a lip ornament, a diamond studded heart ornament, etc.

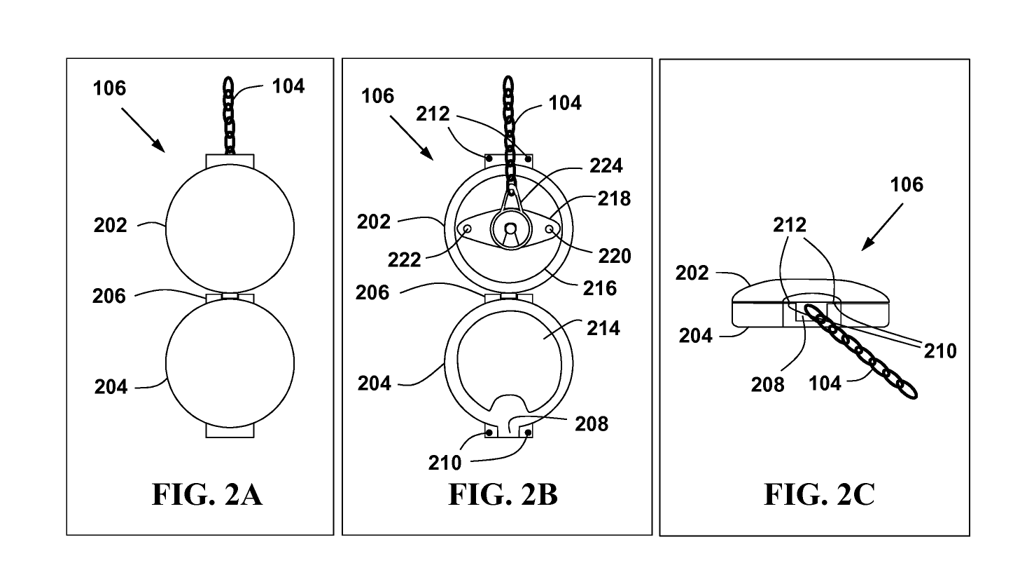

FIG. 2A depicts, in a front view, an exemplary open attachment case 106. The open attachment case may comprise a top portion 202 and a bottom portion 204. The top portion 202 and the bottom portion may be fixedly attached by a hinge 206. The hinge 206 ensures that the bottom portion 204 of the attachment case 106 is not separated or lost from the top portion 202 of the attachment case 106. The outer surface of the top portion 202 and/or the outer surface of the bottom portion 204 of the attachment case 106 may comprise one or more jewels, colors, metals, ornaments, or ornamental designs. When closed (See FIG. 2C), the attachment case 106 may appear to be a single ornament and/or charm. For example, the top portion 202 of the attachment case may have design elements that cause the attachment case to resemble a ladybug and/or a lollypop. As such, any internal components of the attachment case 106 (See FIG. 2B) may be hidden from view until use.

FIG. 2B depicts, in a rear view, an exemplary open attachment case 106. The top portion 202 of the attachment case 106 may comprise one or more magnets 212 that may be configured to engage one or more magnets 210 in the bottom portion 204 of the attachment case 106 when the attachment case is closed (See FIG. 2C). The bottom portion 204 of the attachment case 106 may comprise an insert 214 that may be a reflective surface, e.g., a mirror, and/or a picture frame for holding and displaying one or more pictures. The top portion of the attachment case 106 may also comprise a suction cup 216. The suction cup 216 may be engaged to the top portion 202 of the attachment case 106 by a fastening plate 218. The fastening plate 218 may be secured to the top portion 202 of the attachment case 106 by one or more fasteners 220,222. In some embodiments, the fasteners 220,222 may be screws and/or pins. A pivoting chain attachment device 224 may be disposed about the suction cup 216. The pivoting chain attachment device 224 may be connected to a chain 104. When the attachment case 106 is closed, the chain 104 may exit the inside of the closed attachment case 106 via an opening 208 in the bottom portion 204 of the attachment case 106 that forms an aperture against the top portion 202 of the attachment case 106 when the attachment case 106 is in a closed position. Optionally, the chain may rotate in a clockwise or counterclockwise direction encompassing the outer diameter of the attachment case 106.

FIG. 2C depicts, in a top view, an exemplary closed attachment case 106. When the attachment case 106 is closed, the one or more magnets 212 of the top portion 202 of the attachment case 106 are engaged to the one or more magnets 210 of the bottom portion 202 of the attachment case so that the attachment case 106 does not inadvertently open with ordinary forces applied to it, e.g., ordinary use while attached to a handbag (See FIG. 6) or other bag having one or more straps. The opening 208 for the chain 104 allows the corresponding magnets 210,212 to hold the attachment case 106 closed and minimizes dust, dirt, or other contaminants from contacting the inside of the attachment case 106. The efficacy of the suction cup (216, FIG. 2B) may be lessened by the presence of such contaminants on its surface. In some embodiments, the magnets 210,212 may be replaced by any type of suitable detachable connectors, e.g., a latch, buttons, hook-and-loop fasteners, etc.

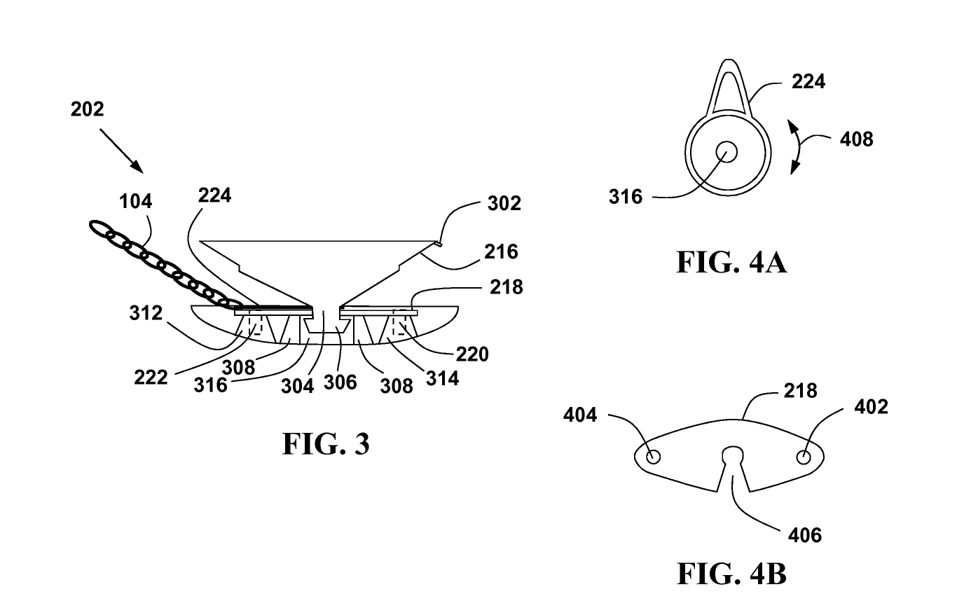

FIG. 3 depicts, in a cross-sectional view, a top portion 202 of an exemplary attachment case. The top portion 202 of the exemplary attachment case may comprise a suction cup 216. The suction cup may comprise a tab 302 for removing the suction cup 216 from a surface. The bulbous end 306 of the suction cup 216 may be disposed in a circular aperture 316 bordered by a circular receiving post 308. One or more fastening posts 312,314 may be configured to receive one or more fasteners 220,222. A fastening plate 218 may be disposed on top of the one or more fastening posts 312,314 and secured against the fastening posts by the one or more fasteners 220,222. The fastening plate 218 may be designed to prevent the suction cup 216 from being pulled out of the circular aperture 316 and may at least partially encircle a narrow portion 304 of the suction cup 216. A pivoting chain attachment device 224 may be disposed on top of the fastening plate 218. The pivoting chain attachment device may encircle the narrow portion 304 of the suction cup 216. The pivoting chain attachment device 224 may be attached to a chain 104 at one end.

FIG. 4A depicts an exemplary pivoting chain attachment device 224. The pivoting chain attachment device 224 may pivot 408 about the circular aperture 316 of the top portion of the attachment case. This allows the attachment case to be utilized in various positions as the chain may rotate about the attachment case via the pivoting chain attachment device 224.

FIG. 4B depicts an exemplary fastening plate 218. The fastening plate 218 may comprise one or more apertures 402,404 for receiving one or more fasteners (220,224, FIG. 3). The fastening plate may comprise an opening 406 to allow the fastening plate 218 to slide around the narrow portion (304, FIG. 3) of the suction cup so as to prevent the bulbous portion (306, FIG. 3) of the suction cup from leaving the circular aperture (316, FIG. 3) of the top portion of the attachment case. The fastening plate 218 prevents the suction cup 216 from being separated from the top portion of the attachment case by securing the suction cup to the top portion of the attachment case.

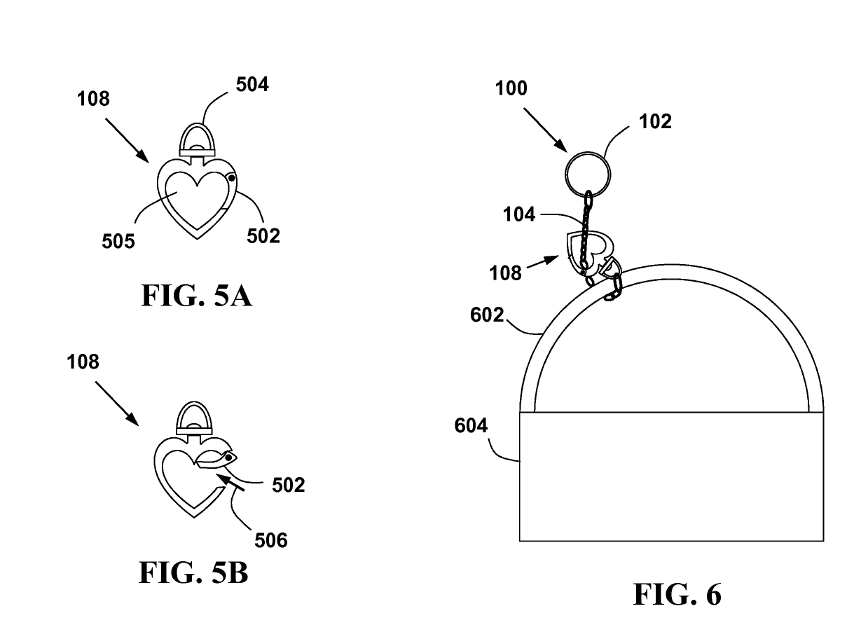

FIG. 5A depicts an exemplary clasp 108 in a closed position. The clasp 108 may comprise a latch 502 and a chain connector 504. The chain connector may be configured to rotate relative to the clasp 108. The clasp may be a heart shape, a circular shape, or any other shape that allows for a chain to connect through a central aperture 505.

FIG. 5B depicts an exemplary clasp 108 in an open position. The latch 502 is open allowing the chain, the annular connector, and/or another connection device to enter through the opening 506.

FIG. 6 depicts an exemplary clasp 108 engaged to a chain wrapped around a strap 602 of a handbag 604. The chain 104 may be connected to the hook and/or clasp (not shown) of the handbag accessory via the annular connector 102.

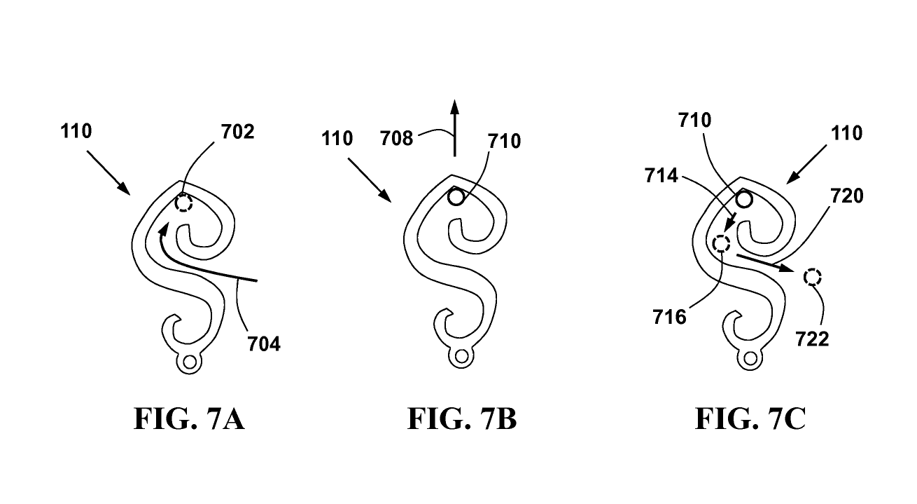

FIG. 7A depicts an engagement procedure of an exemplary hook 110. A receiving post may be inserted directly into the hook or it may be inserted laterally 704 to a resting position 702. The hook 110 may be in an S-shape, a spiral, or any other closed and/or partially open shape that allows for a receiving post to be inserted through the hook 110.

FIG. 7B depicts the resting position of an engaged exemplary hook 110. In a resting position with an upright direction 708 along an axis perpendicular to the ground surface, the receiving post 710 is in a resting position.

FIG. 7C depicts a lateral removal procedure of an exemplary hook 110. From a resting position 710, the hook must be moved in a first direction 714 to an intermediate position 716, and then to an exit position 722 in a second direction 720. As laterally removing the hook requires movement in at least two directions, it lessens the chance of the hook being removed by a single force, e.g., someone pulling on a handbag attached to the hook 110 which is engaged to a receiving post. As such, the design of the hook 110 acts as a theft deterrent as a potential thief would have to either remove the hook 110 by following a curvature of the receiving post or pulling the hook in two opposing directions 714,720 in order to remove the hook 110 from the receiving post. That is, the purse is secured by more than just gravity and a lateral force, e.g., a thief pulling a purse will not readily dislodge the purse holder and thus the likelihood of theft is decreased.

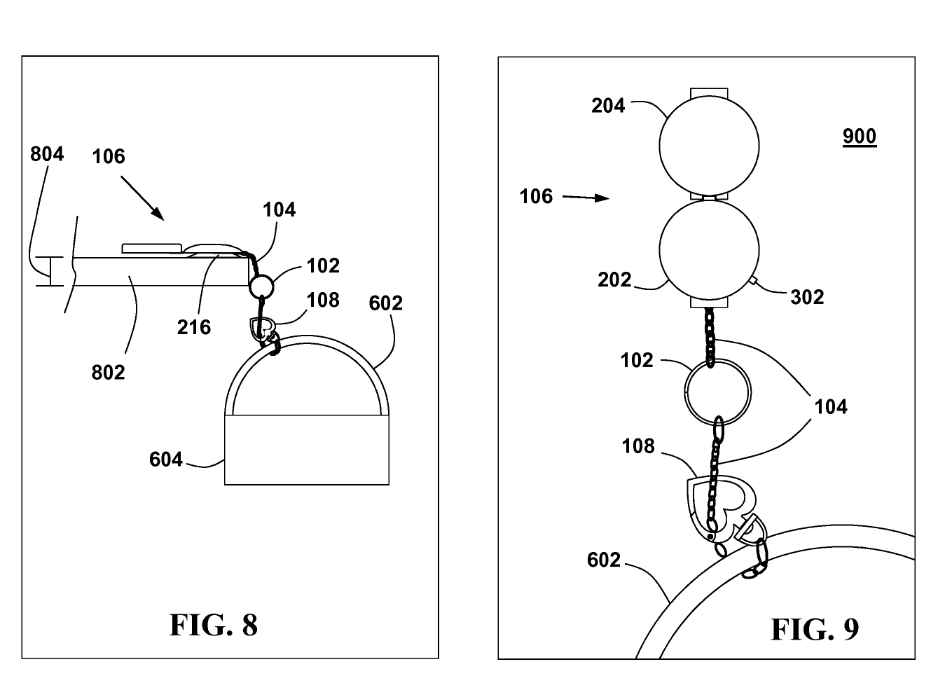

FIG. 8 depicts an exemplary attachment case 106 engaged to a flat horizontal surface 802. The suction cup 216 of the attachment case 106 is engaged to the flat surface 802, e.g., a flat smooth surface. The chain 104 connects the attachment case 106 to the annular connector 102. The annular connector connects to the latch 108 which is securely connected to the strap 602 of the handbag 604. The annular connector may also connect to a hook (not shown). The depth 804 of the surface 802 may extend to the ground. That is, a cantilever effect may not be needed where it requires a maximum depth 804 in order to balance an attached handbag 604. The present invention is secured via a suction cup 216 and connected to the handbag 604 via one or more flexible connectors, e.g., chains 104, and is therefore not limited by the dimensions of the surface. Additionally, if the surface 802 comprised a lip (not shown) on the edge of the surface, e.g., an ornamental molding that extends vertically upwards, the present invention may still operate effectively, whereas a cantilever device may be limited by its geometry to only work on surfaces that do not comprise a lip.

FIG. 9 depicts an exemplary attachment case 106 engaged to a flat vertical surface 900. To utilize the attachment case 106 to hold a handbag, a user separates the top portion 202 of the attachment case 106 from the bottom portion 204 of the attachment case 106 and presses the suction cup, contained in the top portion 202 of the attachment case against the flat vertical surface 900. The handbag is suspended against a vertical surface 900 via its strap 602, connected by the clasp 108 to the annular connector, which is connected to the attachment case 106 by a chain 104. To remove the attachment case from the vertical surface 900, the user pulls on the tab in a perpendicular direction from the flat vertical surface 900 to release the suction of the suction cup. The present invention allows a handbag to be suspended against a vertical surface when no horizontal surfaces are present and/or when it is desired to use a vertical surface instead. The two portions 202,204 of the attachment case 106 are closed (See FIG. 2C) when not in use so as to prevent the buildup of dust, dirt, or other debris on the suction cup and increase the efficacy of the suction cup when being used. A hook (not shown) may also be attached to the annular connector 102 by a chain 104, where the hook may be used to hold one or more additional bags, e.g., a shopping bag, a diaper bag, etc. In some embodiments, the hook (not shown) and the clasp 108 may be used to each hold one or more bags at the same time.

FIG. 10 depicts an exemplary hook 110 engaged to a receiving post 1002. The S-shape of the hook may prevent theft and/or accidental disengagement of the hook 110 from the receiving post 1002 due to forces on the handbag 602.

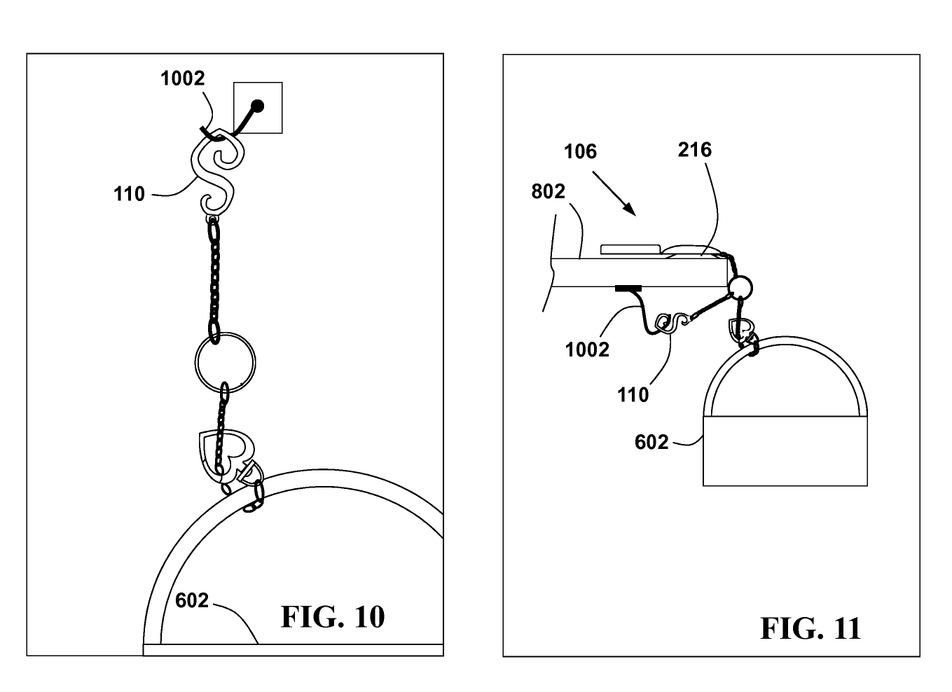

FIG. 11 depicts an exemplary hook 110 engaged to a receiving post 1002 and an exemplary attachment case 106 engaged to a flat surface 802. The handbag accessory may be used with more than one attachment 106,110 so as to decrease the possibility of theft and/or an accidental dropping of the handbag 602 due to the failure of one or more attachments 106,110. For example, if the suction cup 216 disengages from the flat surface 802 because a spilled liquid reduces the suction, then the hook 110 may still support the handbag 602, because it is engaged to the receiving post 1002. Similarly, if the hook 110 is removed from the receiving post 1002, the attachment case is still engaged to the flat surface via the suction cup 216. This fail-safe application may also be applied to vertical surfaces having a receiving post 1002.

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further it is intended that the scope of the present invention is herein disclosed by way of examples and should not be limited by the particular disclosed embodiments described above.

What is claimed is:

1. A device comprising:
an attachment case comprising a top portion of an attachment case and a bottom portion of an attachment case, wherein the top portion of the attachment case and the bottom portion of the attachment case are fixedly attached at one end by a hinge and detachably attached at an opposite end by one or more detachable connectors;
a suction cup, wherein a bulbous end of the suction cup is disposed in the top portion of the attachment case and secured by a fastening plate;
a pivoting chain attachment device comprising a center aperture and a chain connector, wherein the center aperture of the pivoting chain attachment device is disposed about a narrow portion of the suction cup such that the pivoting chain attachment device can rotate freely about the suction cup relative to the attachment case, wherein the chain connector is connected to an attachment case chain, and wherein the suction cup, the fastening plate, and the pivoting chain attachment device are enclosed within the attachment case when the top portion of the attachment case is attached to the bottom portion of the attachment case by the hinge and one or more detachable connectors;
a clasp, wherein the clasp is connected to a clasp chain, and wherein the clasp is configured to laterally receive the clasp chain disposed about at least one strap;
a hook, wherein the hook is connected to a hook chain, and wherein the hook is configured to engage a receiving post; and
an annular connector, wherein the annular connector is configured to connect the attachment case chain, the clasp chain, and the hook chain.

2. The device of claim 1 wherein the one or more detachable connectors are magnets.

3. The device of claim 1 wherein the hook is in the form of an S-shape requiring a lateral movement in two or more directions to laterally disengage the hook from the receiving post.

4. The device of claim 1 wherein the clasp is heart-shaped.

5. The device of claim 1 wherein the bottom portion of the attachment case further comprises an opening that forms an aperture, wherein the size of the aperture allows to pass the attachment chain through when the top portion of the attachment case is attached to the bottom portion of the attachment case by the hinge and one or more detachable connectors.

6. The device of claim 1 wherein the annular connector is a key ring.

7. The device of claim 1 wherein the annular connector is further configured to connect to at least one of: a charm, a second attachment case, a second clasp, and a second hook.

8. A method comprising:
connecting, by a device having a clasp connected to a clasp chain, at least one strap of a bag to the device, wherein the clasp chain is connected to an annular connector;
attaching an attachment case of the device to a flat surface using a suction cup affixed to the attachment case, wherein the attachment case comprises an attachment case chain connected to the annular connector; and
engaging, by a hook of the device, the device to at least one receiving post wherein the hook is detachably attached to the at least one receiving post, and wherein the hook comprises a hook chain connected to the annular connector;
securing the bag to the flat surface, wherein the connected bag is secured by the attached attachment case and engaged hook.

9. The method of claim 8 wherein the hook is in the form of an S-shape requiring a lateral movement in two or more directions to laterally disengage the hook from the at least one receiving post.

10. The device of claim 8 wherein the annular connector is a key ring.

11. The device of claim 8 wherein the annular connector is further configured to connect to at least one of: a charm, a second attachment case, a second clasp, and a second hook.
